(19) United States
(12) Patent Application Publication
(10) Pub. No.: US 2025/0265005 A1
(43) Pub. Date: Aug. 21, 2025

(54) MEMORY SYSTEM, MEMORY CONTROLLER, AND DATA READING METHOD

(71) Applicant: Kioxia Corporation, Tokyo (JP)

(72) Inventor: Sho Shimonomura, Shinagawa Tokyo (JP)

(73) Assignee: Kioxia Corporation, Tokyo (JP)

(21) Appl. No.: 18/829,657

(22) Filed: Sep. 10, 2024

(30) Foreign Application Priority Data
Feb. 21, 2024 (JP) 2024-024677

(51) Int. Cl. G06F 3/06

(52) U.S. Cl. CPC G06F 3/0634; G06F 3/0604; G06F 3/0679

(57) ABSTRACT

According to one embodiment, a memory controller has a speculative reading mode of reading in advance data predicted to be requested by the host from a nonvolatile memory. The memory controller records a physical address of the nonvolatile memory at which data that is last requested to be read by the host is stored, when the host requests data to be read, determines whether to transition to the speculative reading mode, based on a physical address of the nonvolatile memory at which the requested data is stored and the recorded physical address, and when transition to the speculative reading mode, read, from the nonvolatile memory, data in a range determined with respect to a physical address associated with a logical address specified by the host.

### CROSS-REFERENCE TO RELATED APPLICATIONS

This application is based upon and claims the benefit of priority from Japanese Patent Application No. 2024-024677, filed Feb. 21, 2024, the entire contents of which are incorporated herein by reference.

### FIELD

Embodiments described herein relate generally to a memory system, a memory controller, and a data reading method.

### BACKGROUND

A memory controller which controls a NAND flash memory, for example, has the function of translating an address specified by a host (hereinafter, referred to as a logical address) into an address of the flash memory (hereinafter, referred to as a physical address) by a flash translation layer (FTL).

The logical address is translated into the physical address, using a translation table prepared on the basis of a write result from the host and a processing result in a memory system. The translation table is saved in a flash memory of the memory system. A memory controller having only a volatile memory of insufficient capacity to cache the whole translation table needs to partly read the translation table from the flash memory and output it to the volatile memory as necessary. This reading deteriorates the responsiveness to access from the host.

### BRIEF DESCRIPTION OF THE DRAWINGS

FIG. 1 is a block diagram illustrating a configuration example of a memory system of a first embodiment.

FIG. 2 is a diagram for explaining a data reading procedure in a normal mode of the memory system of the first embodiment.

FIG. 3 is a diagram illustrating an example of data reading when data whose read order is contiguous is stored interspersedly in a flash memory.

FIG. 4 is a diagram illustrating an example in which data interspersed in a logical address space is contiguously stored in a physical address space in the memory system of the first embodiment.

FIG. 5 is a diagram illustrating an example in which both logical addresses and physical addresses are made contiguous by writing a large amount of data at once in the memory system of the first embodiment.

FIG. 6 is a diagram illustrating an example of a data structure of each page in the flash memory in the memory system of the first embodiment.

FIG. 7 is a diagram illustrating an example in which a memory controller determines whether data reading from the flash memory performed in response to a read command from a host is targeted at a contiguous physical address in the memory system of the first embodiment.

FIG. 8 is a diagram illustrating an example of data reading from the flash memory by the memory controller when the memory controller determines to transition to a speculative reading mode in the memory system of the first embodiment.

FIG. 9 is a diagram for explaining a data reading procedure in the speculative reading mode of the memory system of the first embodiment.

FIG. 10 is a flowchart illustrating an operating procedure when a read command is received from the host in a normal mode of the memory system of the first embodiment.

FIG. 11 is a flowchart illustrating an operating procedure when a read command is received from the host in the speculative reading mode of the memory system of the first embodiment.

FIG. 12 is a diagram for explaining the determination of whether to transition to the speculative reading mode in the memory system of a second embodiment.

FIG. 13 is a diagram for explaining additional speculative reading in the speculative reading mode of the memory system of the second embodiment.

FIG. 14 is a diagram for explaining the update of a reference physical address and a determination range in the memory system of a third embodiment.

FIG. 15 is a diagram for explaining an example of the determination of whether speculatively read data is valid or invalid by the memory controller of the memory system of a fourth embodiment.

FIG. 16 is a diagram illustrating an example of logical addresses for collation having a ring buffer structure in the memory system of a fifth embodiment.

FIG. 17 is a diagram illustrating an example of speculatively read data in a RAM (cache memory) in the memory system of a sixth embodiment.

FIG. 18 is a first diagram for explaining a list indicating the write order of blocks stored in the memory controller in the memory system of a seventh embodiment.

FIG. 19 is a second diagram for explaining the list indicating the write order of blocks stored in the memory controller in the memory system of the seventh embodiment.

### DETAILED DESCRIPTION

In general, according to one embodiment, a memory system includes a nonvolatile memory, and a memory controller. The memory controller is connectable to a host and controls the nonvolatile memory. The memory controller has a speculative reading mode of reading in advance data predicted to be requested by the host from the nonvolatile memory. The memory controller records a physical address indicating a physical location of the nonvolatile memory at which data that is last requested to be read by the host is stored; when the host requests data to be read, determines whether or not to transition to the speculative reading mode, based on a physical address of the nonvolatile memory at which the requested data is stored and the recorded physical address; and when determining to transition to the speculative reading mode, transition to the speculative reading mode, and read, from the nonvolatile memory, data in a range determined with respect to a physical address associated with a logical address specified by the host.

Embodiments will be described hereinafter with reference to the accompanying drawings.

### First Embodiment

First, a first embodiment will be described.

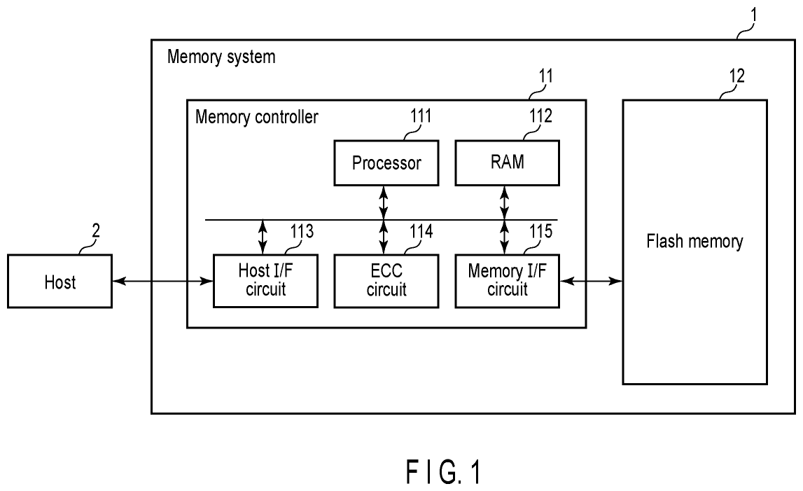

FIG. 1 is a block diagram illustrating a configuration example of a memory system 1 of the first embodiment.

As illustrated in FIG. 1, the memory system 1 comprises a memory controller 11 and a flash memory 12. The memory system 1 may be a universal flash storage (UFS) device comprising the memory controller 11 and the flash memory 12 combined into one package, or may be a solid-state drive (SSD). In FIG. 1, the memory system 1 is illustrated in a state of being connected to a host 2. The memory system 1 is connected to the host 2, for example, via an interface conforming to the PCI Express™ (PCIe™) standard.

The memory controller 11 controls the flash memory 12. The memory controller 11 is connectable to the host 2. The memory controller 11 controls data writing into the flash memory 12 and data reading from the flash memory 12 in response to a command from the host 2. The memory controller 11 may autonomously control data writing into the flash memory 12 and data reading from the flash memory 12, independently of a command from the host 2, for the purpose of preserving data stored in the flash memory 12 or other purposes.

The flash memory 12 is a nonvolatile storage medium. The flash memory 12 is, for example, a NAND flash memory.

The memory controller 11 comprises a processor 111, a random-access memory (RAM) 112, a host interface circuit 113, an error-correcting code (ECC) circuit 114, and a memory interface circuit 115.

The processor 111 controls the operation of the entire memory system 1 by controlling each structural element of the memory controller 11. The processor 111 loads various programs from the flash memory 12 into the RAM 112 and executes the various programs. The various programs include an FTL for carrying out a variety of functions that the memory controller 11 should have such as the function of translating a logical address into a physical address. The processor 111 is, for example, a central processing unit (CPU).

The RAM 112 is a volatile storage medium. The RAM 112 temporarily stores various programs and various data, for example, as a working area of the processor 111.

The host interface circuit 113 communicates with the host 2 in accordance with, for example, a protocol conforming to the NVM Express™ (NVMe™) standard.

The ECC circuit 114 adds an error-correcting code to data written into the flash memory 12. In addition, the ECC circuit 114 uses an error-correcting code added to data read from the flash memory 12, and performs error-correcting processing for detecting and correcting an error included in the read data.

The memory interface circuit 115 controls data writing into the flash memory 12 and data reading from the flash memory 12 on the basis of an instruction of the processor 111.

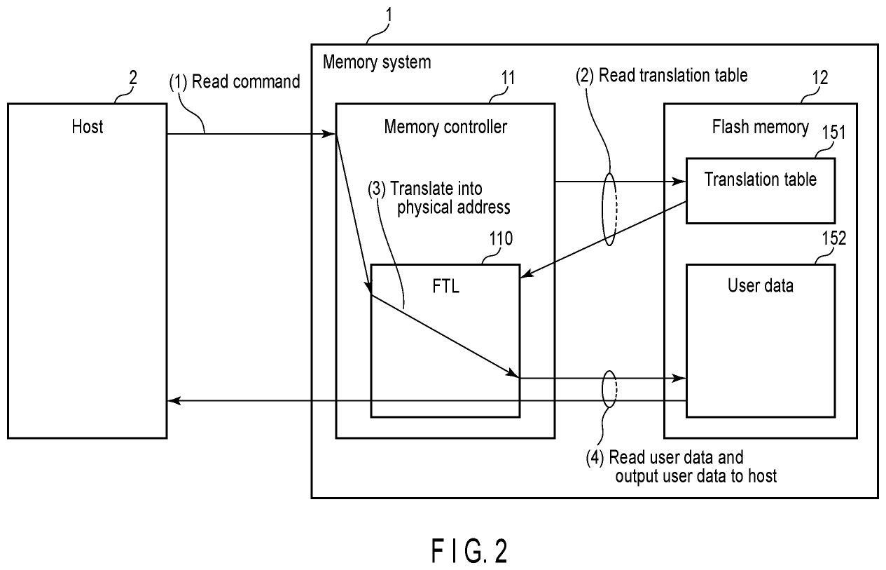

In the memory system 1 of the first embodiment having the above-described configuration, the memory controller 11 has two modes of a normal mode and a speculative reading mode for reading data from the flash memory 12. First, a data reading procedure in the normal mode of the memory system 1 of the present embodiment will be described with reference to FIG. 2.

In the normal mode, when receiving a read command from the host 2 (1), the memory controller 11 first translates a logical address specified by the host 2 into a physical address. To be specific, an FTL 110 reads a translation table 151 recording the correspondence between the logical address and the physical address from the flash memory 12 and outputs it to the RAM 112 (2), and translates the logical address specified by the host 2 into the physical address on the basis of the translation table 151 (3).

When acquiring the physical address corresponding to the logical address specified by the host 2, the memory controller 11 uses the physical address to read user data requested by the host 2 (i.e., user data 152) from the flash memory 12 and transmits it to the host 2 (4).

It is here assumed that in the memory system 1 of the first embodiment, the capacity of the RAM 112 is insufficient to cache the whole translation table 151. More specifically, it is assumed that the capacity that can be reserved in the RAM 112 for caching the translation table 151 is insufficient to cache the whole translation table 151.

For this reason, the FTL 110 partly reads the translation table 151 from the flash memory 12 and outputs it to the RAM 112. When a part of the translation table 151 that is necessary to translate the logical address specified by the host 2 into the physical address is cached in the RAM 112, the FTL 11 can translate the logical address specified by the host 2 into the physical address, using the part of the translation table 151 cached in the RAM 112, without reading the translation table 151 from the flash memory 12. In contrast, when the necessary part of the translation table 151 is not cached in the RAM 112, the FTL 110 reads the necessary part of the translation table 151 from the flash memory 12 to replace a part cashed in the RAM 112 with the necessary part ((2) of FIG. 2), and translates the logical address specified by the host 2 into the physical address. This reading of the translation table 151 deteriorates the responsiveness to access from the host 2.

Note that the RAM 112 contained in the memory controller 11 is here illustrated as a storage medium for caching the translation table 151, but the storage medium is not limited to this. For example, the memory system 1 may comprise a dynamic RAM (DRAM) that is accessible to the memory controller 11 and the FTL 110 may cache the translation table 151 in the DRAM. In this case, too, it is assumed that the capacity that can be reserved in the DRAM for caching the translation table 151 is insufficient to cache the whole translation table 151.

The speculative reading mode will be described next. The speculative reading mode is a mode prepared to improve the responsiveness to access from the host 2.

First, the premises in the memory system 1 of the first embodiment for allowing the memory controller 11 to read data from the flash memory 12 in the speculative reading mode will be described.

The flash memory 12 is a recordable memory. Thus, even data whose read order is contiguous is stored to be interspersed in a noncontiguous manner in the flash memory 12, for example, when the host 2 interposes writing of other data while writing the data.

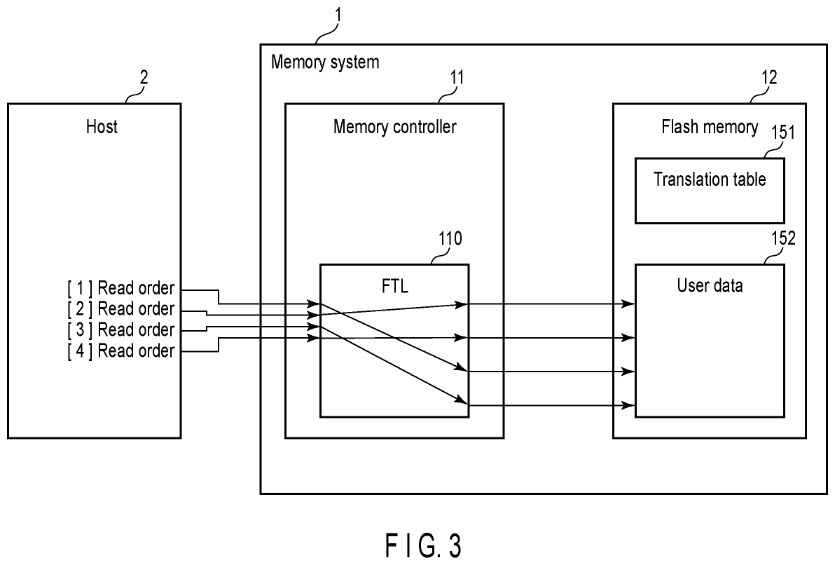

In this case, as illustrated in FIG. 3, even when the host 2 contiguously requests reading of the data, the FTL 110 acquires noncontiguous physical addresses from the translation table 151, and as a result, the memory controller 11 reads data from the flash memory 12 on the basis of the noncontiguous physical addresses.

In view of the above, in the memory system 1 of the first embodiment, the host 2 specifies the logical addresses of data to be contiguously read by the host 2, for example, at a certain timing after writing of the data. The logical addresses are specified by, for example, using one of several commands prepared according to the NVMe™ standard, whose purposes can be freely defined by a vendor.

In response to the specification of the logical addresses, the memory controller 11 reads data stored to be interspersed in a noncontiguous manner in the flash memory 12, invalidates the original data, and rewrites the data into the flash memory 12 to make the physical addresses contiguous.

In addition, when rewriting the data into the flash memory 12 to make the physical addresses contiguous in response to the specification from the host 2, the memory controller 11 handles data in the block of the flash memory 12 in which the data is written, as update-prohibited data. Alternatively, when data is updated in the block, the memory controller 11 moves all the data in the block including the updated data to another block and keeps the physical addresses contiguous.

That is, the speculative reading mode is a mode prepared on the premise that there is data having contiguous physical addresses.

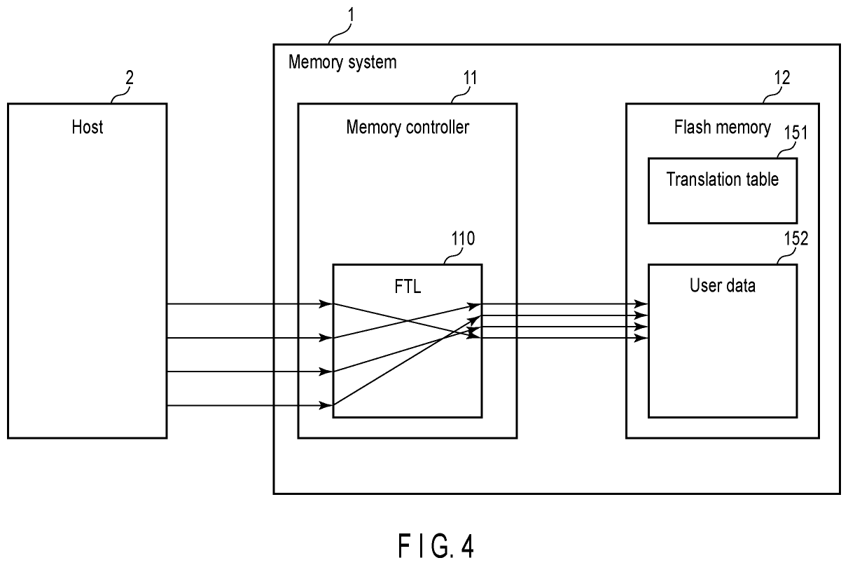

Note that as illustrated in FIG. 4, when noncontiguous logical addresses are specified in order and a command to read data is received from the host 2, there cannot be no possibility that the data is contiguously stored in the flash memory 12. However, in the memory system 1 of the first embodiment, the speculative reading mode can be applied to the reading of data having only contiguous physical addresses.

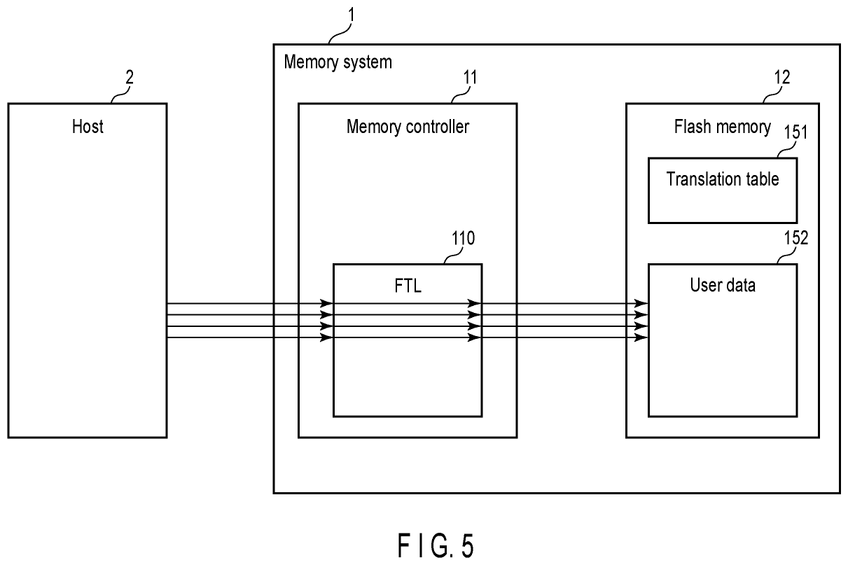

In addition, when the host 2 writes a large amount of data at once, the logical addresses are contiguous and the physical addresses are contiguous as illustrated in FIG. 5. Therefore, the above-described rewriting of data in response to the specification from the host 2 is unnecessary.

Moreover, in the memory system of the first embodiment, the memory controller 11 writes logical address information including a logical address specified by the host 2, together with data, into the flash memory 12, when writing the data into the flash memory 12.

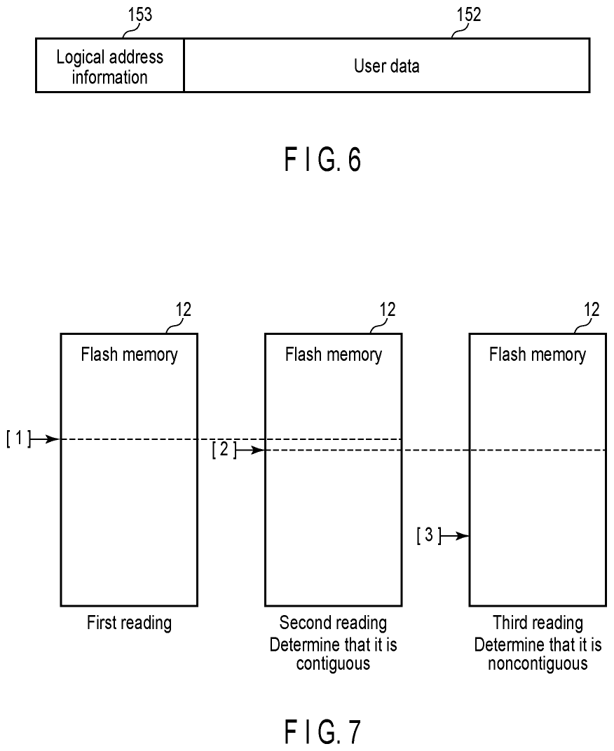

The flash memory 12 includes blocks each including pages. The memory controller 11 writes data into the flash memory 12 and reads data from the flash memory 12 in page units. FIG. 6 illustrates an example of a data structure of each page in the flash memory 12 in the memory system 1 of the first embodiment.

As illustrated in FIG. 6, each of the pages in the flash memory 12 includes an area where user data 152 is stored and an area where logical address information 153 is stored. When receiving a write command from the host 2, the memory controller 11 writes data received from the host 2 (i.e., the user data 152) and the logical address information 153 including a logical address specified by the host 2 into the flash memory 12 in page units as the data structural elements of the data structure illustrated in FIG. 6.

That is, in the memory system 1 of the first embodiment, when data is read from the flash memory 12, a logical address associated with the physical address in the flash memory 12 at which the data is stored can be acquired without referring to the translation table 151.

Next, the condition for determining whether the memory controller 11 transitions from the normal mode to the speculative reading mode will be described.

When the memory system 1 is powered on or reset, the memory controller 11 starts operation in the normal mode. The memory controller 11 reads data from the flash memory 12 in response to a read command from the host 2, and then records the physical address of the flash memory 12 at which the data is stored. In other words, the memory controller 11 records the physical address of the flash memory 12 at which data last read from the flash memory 12 is stored (only in a case where the data is read in response to a read command from the host 2). The memory controller 11 uses this physical address as a reference physical address.

In addition, when translating a specified logical address into a physical address by the FTL 110 in response to a read command from the host 2, the memory controller 11 determines whether the acquired physical address is a contiguous physical address that is larger than the reference physical address by a data reading unit by the host 2.

FIG. 7 is a diagram illustrating an example in which the memory controller 11 determines whether data reading from the flash memory 12 performed in response to a read command from the host 2 is targeted at a contiguous physical address.

In FIG. 7, first, a physical address recorded by first reading is compared with a target physical address of second reading, and it is determined that the second reading is targeted at a physical address contiguous to the reference physical address (i.e., contiguous). Then, the physical address recorded by the second reading is compared with a target physical address of third reading, and it is determined that the third reading is not targeted at a physical address contiguous to the reference physical address (i.e., noncontiguous).

The memory controller 11 determines to transition from the normal mode to the speculative reading mode, when the read target physical address continues to be a physical address contiguous to the reference physical address a preset number of times. This number of times may be a predetermined fixed number of times or may be, for example, a number of times that can be specified as appropriate by system performance tuning. The number of times can be specified by, for example, using one of several commands prepared according to the NVMe™ standard, whose purposes can be freely defined by a vendor, and issuing it from the host 2.

Note that the memory controller 11 continues determining whether the read target physical address is a physical address contiguous to the reference physical address, also after transitioning to the speculative reading mode. When the read target physical address is not a contiguous physical address, the memory controller 11 determines to transition from the speculative reading mode to the normal mode.

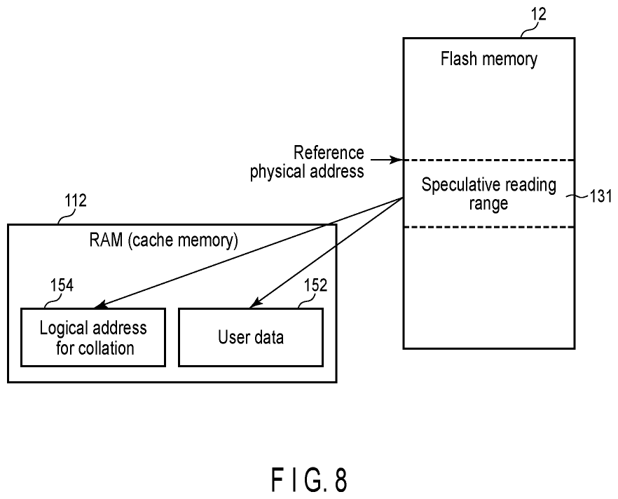

FIG. 8 is a diagram illustrating an example of data reading from the flash memory 12 by the memory controller 11 when the memory controller 11 determines to transition to the speculative reading mode.

When determining to transition to the speculative reading mode, the memory controller 11 determines a speculative reading range 131 with respect to the read target physical address, and reads data in the speculative reading range 131 from the flash memory 12. The data in the speculative reading range 131 is data that is predicted to be requested by the host 2. The width of the speculative reading range 131 may be predetermined or may be, for example, specifiable as appropriate by system performance tuning. The width can be specified by, for example, using one of several commands prepared according to the NVMe™ standard, whose purposes can be freely defined by a vendor, and issuing it from the host 2.

As described above, each of the pages in the flash memory 12 stores logical address information 153 together with user data 152. The memory controller 11 caches the user data 152 in the speculative reading range 131 read from the flash memory 12 in the RAM (cache memory) 112, and caches a logical address included in the logical address information 153 in the RAM 112 as a logical address 154 for collation.

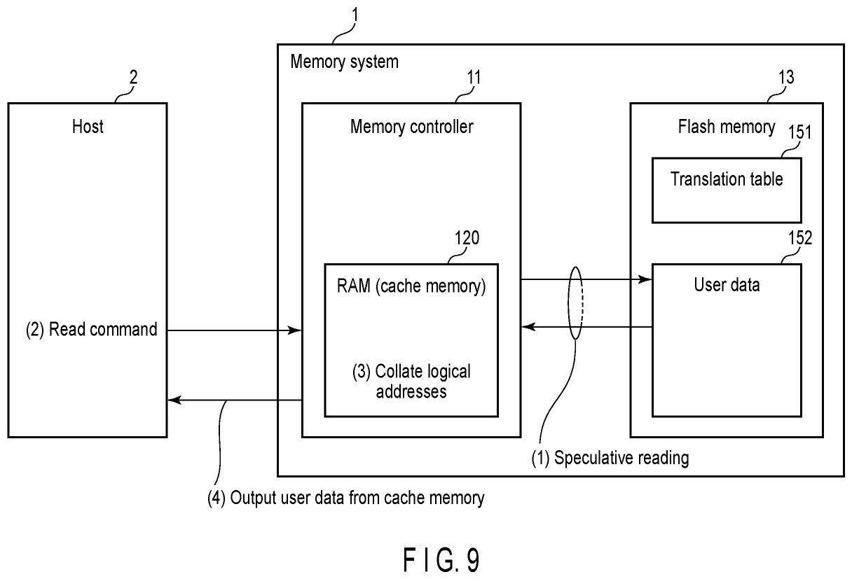

A data reading procedure in the speculative reading mode of the memory system 1 of the first embodiment will be described next with reference to FIG. 9.

In the speculative reading mode, the memory controller 11 performs speculative reading of data predicted to be requested by the host 2 (1). To be specific, the memory controller 11 reads data from a contiguous physical address that is larger than the reference physical address by the data reading unit by the host 2. As described above, the memory system 1 of the first embodiment can acquire a logical address associated with the physical address of the flash memory 12 at which user data 152 is stored, when reading the user data 152 from the flash memory 12. The memory controller 11 also caches this logical address (logical address 154 for collation) in the RAM 112, in addition to the user data 152.

When receiving a read command from the host 2 (2), the memory controller 11 collates a logical address specified by the host 2 with the logical address cached in the RAM 112 (3). When the logical address specified by the host 2 and the logical address cached in the RAM 112 match, the memory controller 11 transmits the user data 152 cached in the RAM 112 to the host 2 (4).

In addition, when the logical address specified by the host 2 and the logical address cached in the RAM 112 match, the memory controller 11 determines that the current reading is targeted at a physical address contiguous to the reference physical address (i.e., contiguous). In this case, the memory controller 11 continues the speculative reading mode. When continuing the speculative reading mode, the memory controller 11 updates the reference physical address to the target physical address of the current reading. Then, the memory controller 11 reads data from a contiguous physical address that is larger than the reference physical address by the data reading unit by the host 2. That is, the memory controller 11 performs speculative reading of data predicted to be requested by the host 2.

The memory controller 11 deletes data transmitted to the host 2 and a logical address corresponding to the data from the RAM 112, and caches speculatively read data and a logical address corresponding to the speculatively read data in the RAM 112.

When the logical address specified by the host 2 and the logical address cached in the RAM 112 do not match, the memory controller 11 does not continue the speculative reading mode and transitions from the speculative reading mode to the normal mode.

In this manner, in the memory system 1 of the first embodiment, the memory controller 11 has the speculative reading mode. The memory controller 11 adaptively switches between the normal mode and the speculative reading mode in accordance with the issuance condition of a read command by the host 2. By virtue of the speculative reading mode, the memory system 1 of the first embodiment can be expected to reduce the opportunities to read the translation table 151 from the flash memory 12. In addition, the memory system 1 of the first embodiment can be expected to substitute the reading of user data 152 from the RAM 112 for the reading of user data 152 from the flash memory 12 at the timing of the reception of a read command from the host 2.

That is, the memory system 1 of the first embodiment can improve the responsiveness to access from the host 2.

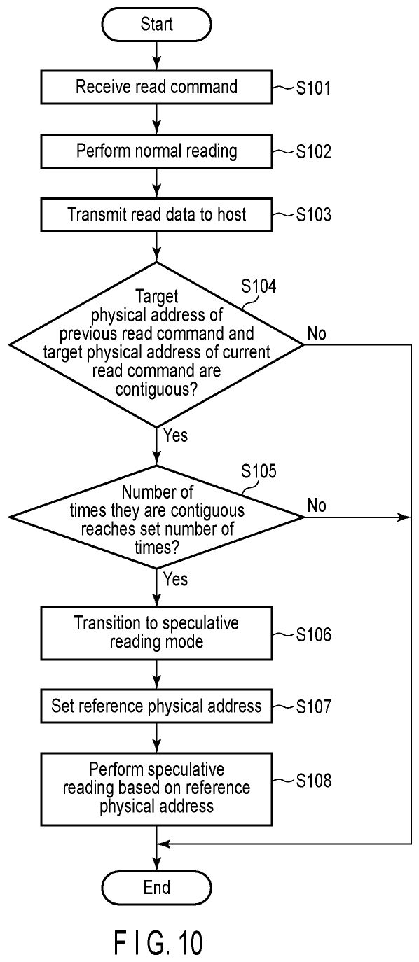

FIG. 10 is a flowchart illustrating an operating procedure when a read command is received from the host 2 in the normal mode of the memory system 1 of the first embodiment.

When receiving a read command from the host 2 (S101), the memory controller 11 performs the normal reading of translating a logical address specified by the host 2 into a physical address with the translation table 151 and reading data from the flash memory 12 (S102). The memory controller 11 transmits the read data to the host 2 (S103).

The memory controller 11 determines whether a target physical address of a previous read command and a target physical address of a current read command are contiguous (S104). When they are contiguous (S104: Yes), the memory controller 11 then determines whether the number of times they are contiguous reaches a set number of times (S105). When the number of times they are contiguous reaches the set number of times (S105: Yes), the memory controller 11 transitions from the normal mode to the speculative reading mode (S106).

When transitioning to the speculative reading mode, the memory controller 11 sets the target physical address of the current read command as the reference physical address (S107), performs speculative reading based on the reference physical address (S108), and ends the processing performed when a read command is received from the host 2.

In contrast, when the target physical address of the previous read command and the target physical address of the current read command are not contiguous (S104: No), or when the number of times they are contiguous does not reach the set number of times (S105: No), the memory controller 11 does not transition to the speculative reading mode and ends the processing performed when a read command is received from the host 2.

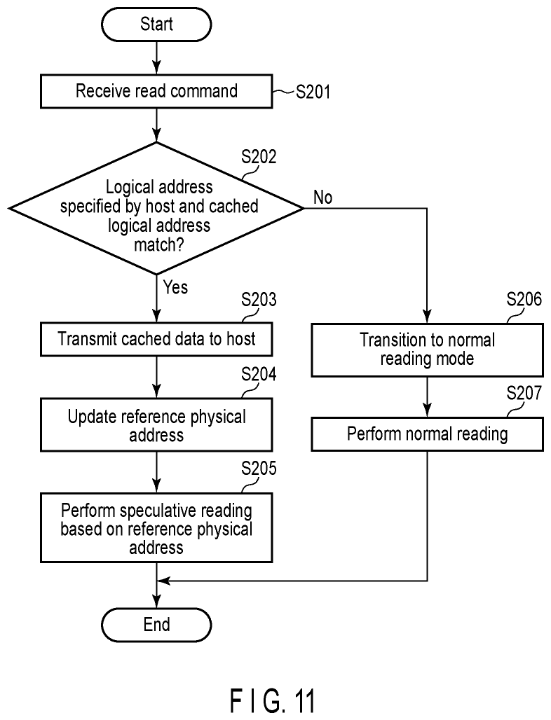

FIG. 11 is a flowchart illustrating an operating procedure when a read command is received from the host 2 in the speculative reading mode of the memory system 1 of the first embodiment.

When receiving a read command from the host 2 (S201), the memory controller 11 determines whether a logical address specified by the host 2 and a logical address cached by speculative reading match (S202). When they match (S202: Yes), the memory controller 11 transmits data cached by speculative reading to the host 2 (S203).

In addition, when the logical address specified by the host 2 and the logical address cached by speculative reading match, the memory controller 11 continues the speculative reading mode. The memory controller 11 updates the reference physical address to a target physical address of a current read command (S204), and performs speculative reading based on the reference physical address (S205).

In contrast, when the logical address specified by the host 2 and the logical address cached by speculative reading do not match (S202: No), the memory controller 11 does not continue the speculative reading mode and transitions from the speculative reading mode to the normal mode (S206). When transitioning to the normal mode, the memory controller 11 performs the normal reading of translating a logical address specified by the host 2 into a physical address with the translation table 151 and reading data from the flash memory 12 (S207).

In a storage device comprising an FTL, as the size of user data allocated to each logical address (hereinafter, referred to as a logical block size) becomes smaller, the proportion of the reading of a translation table in the reading of user data becomes relatively greater. When the logical block size is 16 KiB for a logical address of 4 bytes, the proportion of the reading of the translation table is only 0.24%. In contrast, when the logical block size is 4 KiB for a logical address of 4 bytes, the proportion of the reading of the translation table is at least 0.98%. Therefore, as the size of user data allocated to each logical address becomes smaller, an advantageous effect achieved by the memory system 1 of the first embodiment becomes greater.

As described above, the memory system 1 of the first embodiment can improve the responsiveness to access from the host 2 by the reduction of the opportunities to read the translation table 151 in the speculative reading mode and the like.

### Second Embodiment

A second embodiment will be described next. Here, the same symbols are used for the same structural elements as those of the first embodiment, and the description thereof is omitted.

In the memory system 1 of the second embodiment, the determination of whether to transition to the speculative reading mode in the memory system 1 of the first embodiment is improved.

While data in the flash memory 12 is reordered in the order of accesses from the host 2, there is a possibility that the reproducibility of the read order may be disturbed when the host 2 is a computer that operates in multithreading or the like. On the other hand, the disturbance of the order can be expected to be local replacement such as replacement of preceding and following data.

In view of the above, in the memory system 1 of the second embodiment, the physical address for determining contiguous reading is not only one physical address that is larger by the data reading unit by the host 2 as in the memory system 1 of the first embodiment, but is a range of physical addresses preceding and following the physical address. When a physical address in the range is next read, it is assumed that physical addresses are contiguously read.

The reference physical address is updated only when the read target physical address is larger than the reference physical address. The determination range is a range of addresses preceding and following the updated reference physical address. The size of the determination range is, for example, equivalent to the size of the cache reserved in the RAM 112. The width of the determination range can be freely set by, for example, issuing a command from the host 2.

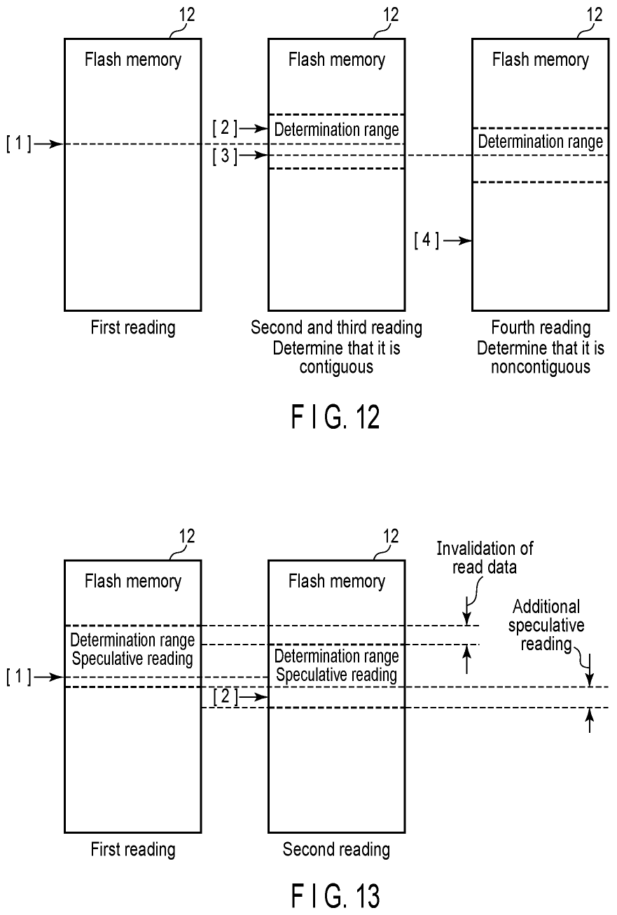

FIG. 12 is a diagram for explaining the determination of whether to transition to the speculative reading mode in the memory system 1 of the second embodiment.

In the memory system 1 of the second embodiment, too, the memory controller 11 transitions to the speculative reading mode when the reading of a contiguous physical address continues a preset number of times as in the memory system 1 of the first embodiment. In FIG. 12, it is assumed that the number of times that is the criterion for determining to transition to the speculative reading mode is set to four.

In FIG. 11, first, the determination range having a width equivalent to the cache size, for example, is set on the basis of a physical address recorded by first reading (i.e., the reference physical address). Because second reading is not targeted at a physical address contiguous to the reference physical address, it is determined that the second reading is noncontiguous in the memory system 1 of the first embodiment. In contrast, in the memory system 1 of the second embodiment, the second reading is within the determination range having the width equivalent to the cache size, for example, and it is thus determined that the reading is contiguous. However, since the read target physical address is not a physical address larger than the reference physical address, the reference physical address is not updated. Accordingly, the determination range is not updated either.

Third reading is also within the determination range having the width equivalent to the cache size, for example, and it is thus determined that the third reading is contiguous. Since the third reading is targeted at a physical address larger than the reference physical address, the reference physical address is updated and the determination range is also updated accordingly.

Fourth reading is not within the determination range having the width equivalent to the cache size, for example, and it is thus determined that the fourth reading is noncontiguous. Although not illustrated in FIG. 12, in this case, the reference physical address is updated and the determination range is also updated accordingly. The next reading is second reading. When it is determined that the fourth reading is contiguous, the memory controller 11 transitions from the normal mode to the speculative reading mode.

FIG. 13 is a diagram for explaining additional speculative reading in the speculative reading mode of the memory system 1 of the second embodiment.

When transitioning to the speculative reading mode, the memory controller 11 reads data in the determination range determined on the basis of the reference physical address and caches the data in the RAM 112 (i.e., speculative reading). When the determination range is updated in accordance with the update of the reference physical address, the memory controller 11 deletes cached data corresponding to a part of the previous determination range that is outside the current determination range from the RAM 112. In addition, the memory controller 11 reads data corresponding to a part of the current determination range that does not overlap the previous determination range from the flash memory 12 and caches the data in the RAM 112.

In FIG. 12, at the first reading, the reference physical address is updated and the determination range is updated accordingly. To be specific, the data corresponding to the part of the previous determination range that is outside the current determination range is deleted from the RAM 112, and the data corresponding to the part of the current determination range that does not overlap the previous determination range is read.

The second reading is reading targeted at a part of the determination range added by the first reading. In this manner, in the memory system 1 of the second embodiment, the determination range has a certain degree of width, in view of the fact that the reproducibility of the read order may be disturbed but the disturbance can be expected to be local replacement, in consideration of the case where the host 2 is a computer that operates in multithreading or the like as well.

Accordingly, the memory system 1 of the second embodiment can enhance the possibility of continuing the speculative reading mode even when the reproducibility of the read order is disturbed, and can further improve the responsiveness to access from the host 2.

### Third Embodiment

A third embodiment will be described next. In this embodiment, too, the same symbols are used for the same structural elements as those of the first embodiment, and the description thereof is omitted.

In the memory system 1 of the third embodiment, the method of updating the determination range in the memory system 1 of the second embodiment is improved.

In the memory system 1 of the second embodiment, when the read target physical address is larger than the reference physical address, both the reference physical address and the determination range are updated. In that case, when the read target physical address is an unread small physical address after a physical address that is within the determination range but is extremely large, there is a high possibility that it is determined that they are noncontiguous.

In view of the above, in the memory system 1 of the third embodiment, an update range is further provided on the basis of the reference physical address, and only when reading is targeted at the update range, the reference physical address and the determination range are updated.

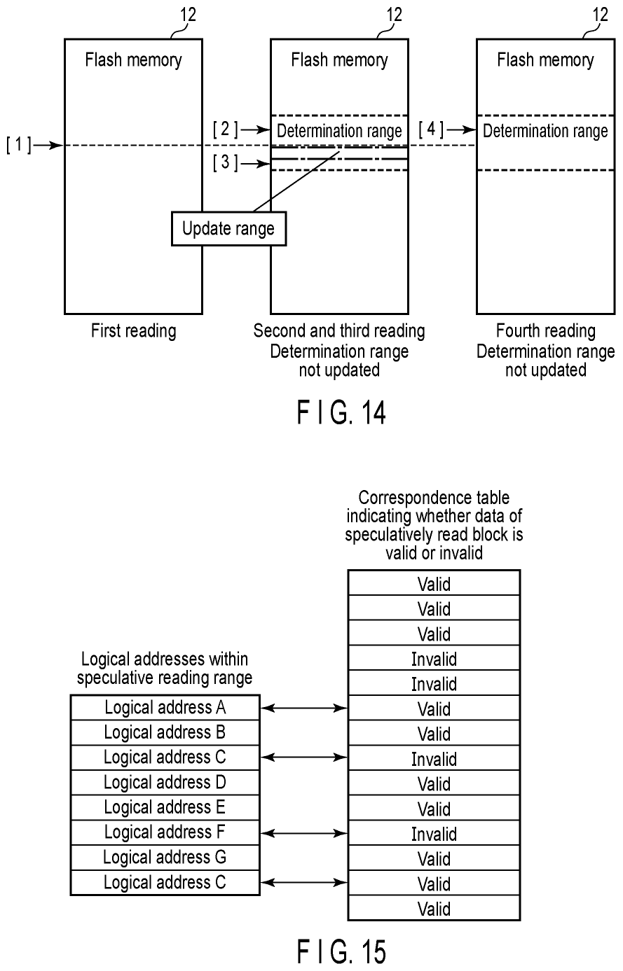

FIG. 14 is a diagram for explaining the update of the reference physical address and the determination range in the memory system 1 of the third embodiment.

In FIG. 14, second reading and third reading targeted at the determination range set by first reading are performed, but they are both outside the update range, so that the reference physical address and the determination range are not updated.

In this manner, the memory system 1 of the third embodiment can enhance the possibility of continuing the speculative reading mode and can further improve the responsiveness to access from the host 2 by not updating the determination range when the reproducibility of the read order is disturbed and the read target physical address is a physical address that is within the determination range but is extremely large.

### Fourth Embodiment

A fourth embodiment will be described next. In this embodiment, too, the same symbols are used for the same structural elements as those of the first embodiment, and the description thereof is omitted.

The memory system 1 of the fourth embodiment is an example illustrating a method of eliminating the prohibition on the update of data in a block in the flash memory 12 into which data to be contiguously read has been written by the host 2 or the restriction on the movement of data in block units in accordance with data update, which has been a premise in the memory system 1 of the first embodiment.

The validity or invalidity of data in the flash memory 12 is managed by the memory controller 11, more specifically, by the FTL 110 as a correspondence table.

When outputting speculatively read data to the host 2, the memory controller 11 refers to the correspondence table to output the data. This prevents the output of invalidated user data 152 in a block to the host 2.

When the speculatively read data includes data that matches a logical address specified by the host but the data is invalidated in the correspondence table, the memory controller 11 determines that the speculatively read data includes no data that can be output, and ends speculative data reading. The memory controller 11 transitions from the speculative reading mode to the normal mode, and resumes the determination of the contiguousness of reading by the host 2.

In addition, when the correspondence table shows that data at the lower limit of the determination range is invalid, the memory controller 11 continues speculative reading and updates the determination range and the update range until the data at the lower limit becomes valid data.

The correspondence table is assumed to be a table associated with physical blocks of the flash memory 12. Since the correspondence table is a table associated with the physical addresses, it has no correlation with the access patterns of logical addresses. In addition, the correspondence table needs to be read from the flash memory 12 and output to the RAM 112, but its information merely indicate validity or invalidity, and has an amount of data sufficiently smaller than that of the translation table 151 for translating a logical address into a physical address.

FIG. 15 is a diagram for explaining an example of the determination of whether speculatively read data is valid or invalid by the memory controller 11.

In the example of FIG. 15, the memory controller 11 can determine that a speculatively read sixth logical address F from the top is already invalidated from the correspondence table.

In addition, as in the case of a logical address C, speculatively reading data of the same logical address in the same block is conceivable, and one of the data is always invalidated. Thus, in the example of FIG. 15, too, the memory controller 11 can acquire valid data from speculatively read data in due course by continuing referring to the correspondence table in the determination range (speculative reading range 131). That is, when data that matches a logical address specified by the host 2 is found to be cached but is invalidated in the correspondence table, the memory controller 11 examines whether other data of the same logical address is cached.

In addition, in the example of FIG. 15, two pieces of data before a logical address A are already invalidated, and the range of these pieces of data is not the lower limit of the determination range of speculative reading. When they are about to be set to the lower limit of the determination range, the memory controller 11 continues speculative reading to the location of the logical address A.

As described above, the memory system 1 of the fourth embodiment eliminates the prohibition on the update of data in a block in the flash memory 12 into which data to be contiguously read has been written by the host 2 or the restriction on the movement of data in block units in accordance with data update, which has been a premise in the memory system 1 of the first embodiment.

### Fifth Embodiment

A fifth embodiment will be described next. In this embodiment, too, the same symbols are used for the same structural elements as those of the first embodiment, and the description thereof is omitted.

In the memory system 1 of the fifth embodiment, the method of referring to the logical addresses 154 for collation in the memory system 1 of the fourth embodiment is improved.

In the memory system 1 of the fourth embodiment, it is necessary to perform reference processing again to find a valid logical address even when a logical address first found is invalid or to perform reference processing until the reference to all logical addresses 154 for collation is completed, in consideration of update in the same block as in the case of the logical address C of FIG. 15. Therefore, in the memory system 1 of the fourth embodiment, the reference processing increases and the processing time increases accordingly. In addition, since the control for performing the reference processing again increases, the control mechanism is complicated.

In view of the above, the memory system 1 of the fifth embodiment comprises a mechanism that can determine whether data is valid or invalid only by a first matched logical address. This eliminates the necessity to perform the reference processing again, which has been necessary in the memory system 1 of the fourth embodiment.

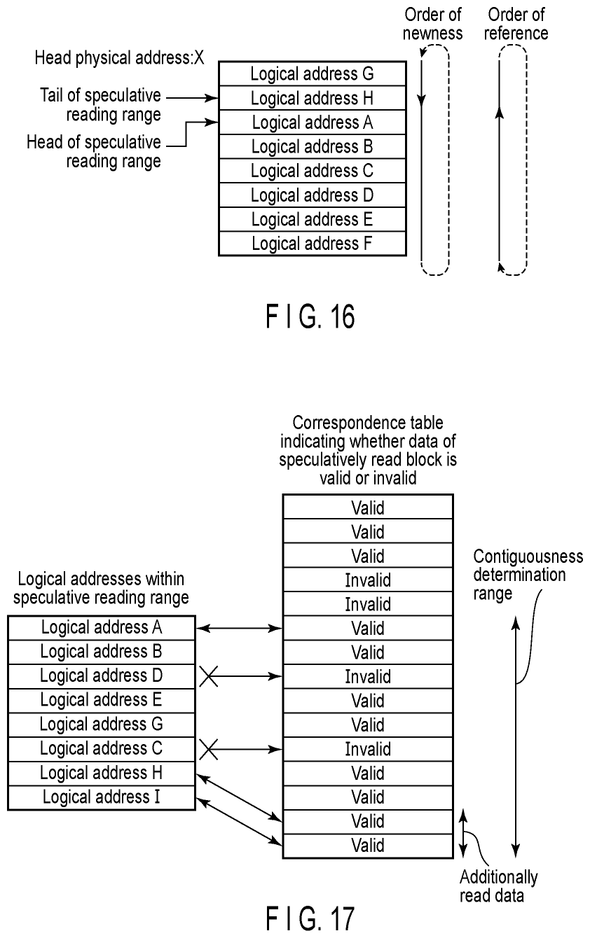

In the memory system 1 of the fifth embodiment, the logical addresses 154 for collation have a ring buffer structure. FIG. 16 is a diagram illustrating an example of the logical addresses 154 for collation having the ring buffer structure in the memory system 1 of the fifth embodiment.

The memory controller 11 stores information at the head and the tail of the ring buffer. When the determination range is updated, the memory controller 11 overwrites from logical address information corresponding to the smallest physical address (i.e., the head of the ring buffer). When referring to logical address information, the memory controller 11 starts referring in descending order from the location of a large physical address (i.e., the tail of the ring buffer).

Accordingly, when the same logical addresses are included in the determination range, the logical address that is referred to first, that is, the logical address of the largest physical address, corresponds to the latest logical address and physical address. This is because data of a larger physical address is the latest data due to the characteristics of the flash memory 12.

In this manner, the memory system 1 of the fifth embodiment can determine whether data is valid or invalid only by a logical address that is matched first, and can improve the responsiveness to access from the host 2, compared to the memory system 1 of the fourth embodiment.

### Sixth Embodiment

A sixth embodiment will be described next. In this embodiment, too, the same symbols are used for the same structural elements as those of the first embodiment, and the description thereof is omitted.

In the memory system 1 of the fourth embodiment, data that is invalid in the correspondence table also has been speculatively read from the flash memory 12, whereas the memory system 1 of the sixth embodiment does not read data that is invalid in the correspondence table.

FIG. 17 is a diagram illustrating an example of speculatively read data in the RAM (cache memory) 112 in the memory system 1 of the sixth embodiment.

In the example of FIG. 17, eight pieces of user data 152 can be cached in the RAM 112. In addition, fifteen pieces of data can be written into each block of the flash memory 12, and the start point of the determination range is a sixth physical address.

In this case, since the correspondence table shows that eighth data and eleventh data after sixth data are invalid, the memory controller 11 speculatively reads eight pieces of data from the sixth data to fifteenth data excluding the eighth data and the eleventh data from the flash memory 12 and outputting them into the RAM 112.

In this manner, in the memory system 1 of the sixth embodiment, since all of the cached user data 152 is valid, data first found by referring to a logical address of the speculative reading range can be output to the host unlike in the memory system 1 of the fourth embodiment.

In addition, since unnecessary data is not read and output to the RAM 112, speculative reading can be further additionally performed for free area. Regarding the determination range of contiguous reading as well, it is determined that the reading of data additionally read and output to the cache memory is also contiguous.

As described above, the memory system 1 of the sixth embodiment can improve the responsiveness to access from the host 2, compared to the memory system 1 of the fourth embodiment.

### Seventh Embodiment

A seventh embodiment will be described. In this embodiment, too, the same symbols are used for the same structural elements as those of the first embodiment, and the description thereof is omitted.

In the memory systems 1 of the first embodiment to the sixth embodiment, speculative reading is completed in one block of the flash memory 12, and when the reading range moves to another block, speculative reading needs to be stopped once.

In view of the above, the memory system 1 of the seventh embodiment enables speculative reading to be continued even when a block to be read is switched.

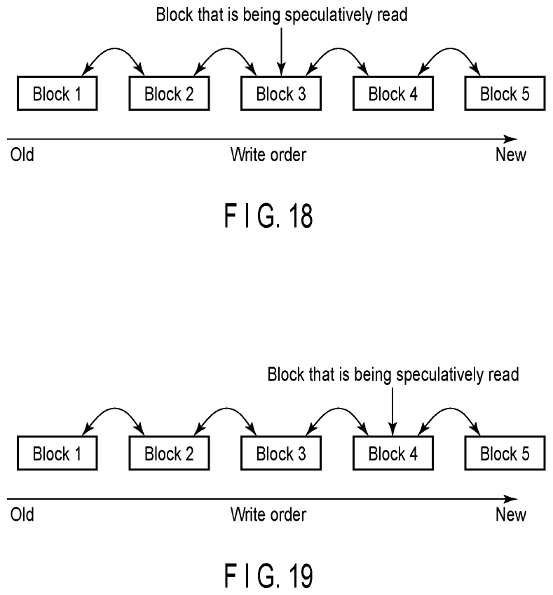

In the memory system 1 of the seventh embodiment, the memory controller 11 stores a list indicating the write order of blocks. FIG. 18 and FIG. 19 are diagrams for explaining the list indicating the write order of blocks stored in the memory controller 11 in the memory system 1 of the seventh embodiment.

In the list, all the blocks in the flash memory 12 can be connected. Note that only blocks in which valid data is written are connected. In the examples of FIG. 18 and FIG. 19, five blocks are connected.

When finishing writing all data into a block, the memory controller 11 connects the block to the end of the list. When all the data in a block is invalided, the memory controller 11 excludes the block from the list.

The memory controller 11 speculatively reads data in a block of the flash memory 12, and when the reading range reaches the tail of the block, resumes speculative reading from the head of a block connected next to the speculatively read block in the write order list. In the examples of FIG. 18 and FIG. 19, the reading range reaches the tail of a block 3, and speculative reading is resumed from the head of a block 4 connected next to the block 3 on the basis of the list.

In the case of a block at the end of the list, the memory controller 11 ends speculative reading when reaching the tail of the block.

Accordingly, in the memory system 1 of the seventh embodiment, speculative reading can be continued even when data to be read is contiguously written over blocks. In the case of the flash memory 12 having a small block size of approximately 10 MiB, there is a high possibility that data is written over blocks. Thus, the memory system 1 of the seventh embodiment can sufficiently achieve the advantageous effect of speculative reading, compared to the memory systems 1 of the first embodiment to the sixth embodiment.

In addition, depending on a write command from the host 2, a data area frequently speculatively read may be written over blocks. In this case, the advantageous effect of speculative reading can be sufficiently achieved by adopting the mechanism of the memory system 1 of the seventh embodiment.

As described above, the memory system 1 of the seventh embodiment can easily continue speculative reading even when the block size of the flash memory 12 is small, and can continuously achieve the advantageous effect of speculative reading. For example, when the block size of the flash memory 12 is 10 MiB and reading of 4 KiB is continued four times to transition to speculative reading, 0.39% of data is read in the normal mode in the memory systems 1 of the first embodiment to the sixth embodiment. In contrast, in the memory system 1 of the seventh embodiment, 0.39% of data also can be speculatively read.

In this manner, the memory system 1 of the seventh embodiment can improve the responsiveness to access from the host 2, compared to the memory systems 1 of the first embodiment to the sixth embodiment.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory; and
a memory controller connectable to a host and configured to control the nonvolatile memory, wherein
the memory controller has a speculative reading mode of reading in advance data predicted to be requested by the host from the nonvolatile memory,
the memory controller is configured to
record a physical address indicating a physical location of the nonvolatile memory at which data that is last requested to be read by the host is stored,
determine, when the host requests data to be read, whether or not to transition to the speculative reading mode, based on a physical address of the nonvolatile memory at which the requested data is stored and the recorded physical address, and
transition, when determining to transition to the speculative reading mode, to the speculative reading mode, and read, from the nonvolatile memory, data in a range determined with respect to a physical address associated with a logical address specified by the host.

2. The memory system of claim 1, wherein
when the physical address of the nonvolatile memory at which the data requested by the host is stored continues to be an address that is larger than the recorded physical address by a size of a data reading unit by the host a preset number of times, the memory controller is configured to determine to transition to the speculative reading mode.

3. The memory system of claim 1, wherein
when the physical address of the nonvolatile memory at which the data requested by the host is stored continues to be an address in a range determined with respect to the recorded physical address a preset number of times, the memory controller is configured to determine to transition to the speculative reading mode.

4. The memory system of claim 3, wherein
the memory controller is configured to
determine whether or not the physical address of the nonvolatile memory at which the data requested by the host is stored is larger than the recorded physical address;
update, when the physical address of the nonvolatile memory at which the data requested by the host is stored is larger than the recorded physical address, the recorded physical address to the physical address of the nonvolatile memory at which the data requested by the host is stored; and
omit, when the physical address of the nonvolatile memory at which the data requested by the host is stored is not larger than the recorded physical address, to update the recorded physical address.

5. The memory system of claim 4, wherein
when the physical address of the nonvolatile memory at which the data requested by the host is stored is larger than the recorded physical address, the memory controller is configured to
determine whether or not a difference between the physical address of the nonvolatile memory at which the data requested by the host is stored and the recorded physical address is less than or equal to a threshold value;
update, when the difference is less than or equal to the threshold value, the recorded physical address to the physical address of the nonvolatile memory at which the data requested by the host is stored; and
omit, when the difference exceeds the threshold value, to update the recorded physical address.

6. The memory system of claim 1, wherein
the nonvolatile memory includes blocks each including pages, and
the memory controller is configured to
perform, when the host requests data to be written, writing into the nonvolatile memory to store a logical address specified by the host in a first area of the pages and to store data received from the host in a second area of the pages, and
determine, in the speculative reading mode, whether or not to continue the speculative reading mode, based on the logical address specified by the host and a logical address read from the nonvolatile memory together with the data predicted to be requested by the host.

7. The memory system of claim 6, wherein
in the speculative reading mode, the memory controller is configured to determine, when the logical address specified by the host matches the logical address read from the nonvolatile memory together with the data predicted to be requested by the host in a case where the host requests data to be read, to continue the speculative reading mode.

8. The memory system of claim 6, wherein
in the speculative reading mode, the memory controller is configured to read, from the nonvolatile memory, data stored at a location indicated by an address that is larger than the physical address associated with the logical address specified by the host by a size of a data reading unit by host.

9. The memory system of claim 6, wherein
in the speculative reading mode, the memory controller is configured to
determine whether or not the physical address associated with the logical address specified by the host is larger than the recorded physical address;
update, when the physical address associated with the logical address specified by the host is larger than the recorded physical address, the recorded physical address to the physical address associated with the logical address specified by the host, and read data in a part of a range determined with respect to the updated physical address from the nonvolatile memory, the part of the range determined with respect to the updated physical address not overlapping a range determined with respect to the pre-update physical address; and
omit, when the physical address associated with the logical address specified by the host is not larger than the recorded physical address, to update the recorded physical address.

10. The memory system of claim 9, wherein
when the physical address associated with the logical address specified by the host is larger than the recorded physical address, the memory controller is configured to
determine whether or not a difference between the physical address associated with the logical address specified by the host and the recorded physical address is less than or equal to a threshold value,
update, when the difference is less than or equal to the threshold value, the recorded physical address to the physical address associated with the logical address specified by the host, and read data in a part of a range determined with respect to the updated physical address from the nonvolatile memory, the part of the range determined with respect to the updated physical address not overlapping a range determined with respect to the pre-update physical address; and
omit, when the difference exceeds the threshold value, to update the recorded physical address.

11. The memory system of claim 1, wherein
the memory controller is configured to
manage a correspondence table indicating whether data stored in the nonvolatile memory is valid or invalid, and
determine, in the speculative reading mode, when data of the logical address specified by the host is read in advance from the nonvolatile memory as the data predicted to be requested by the host, whether or not the read data is valid or invalid, based on the correspondence table, and
transmit, when the read data is valid, the read data to the host.

12. The memory system of claim 11, wherein
the memory controller is configured to
read and output the data predicted to be requested by the host to a cache memory having a ring buffer structure, and
refer to the cache memory in descending order of physical addresses and retrieves data of the logical address specified by the host.

13. The memory system of claim 1, wherein
the memory controller is configured to
manage a correspondence table indicating whether data stored in the nonvolatile memory is valid or invalid, and
determine, when reading the data predicted to be requested by the host from the nonvolatile memory, whether or not the data to be read is valid or invalid, based on the correspondence table, and
read, when the read to be read is valid, the data from the nonvolatile memory.

14. The memory system of claim 13, wherein
when the data to be read is invalid, the memory controller is configured to read data predicted to be requested by the host from the nonvolatile memory.

15. The memory system of claim 1, wherein
the nonvolatile memory includes blocks each including pages;
the memory controller is configured to manage a list indicating an order of the blocks used to write data of the host, and is allowed to continue reading of the data predicted to be requested by the host over two blocks, based on the list.

16. A memory controller connectable to a host and configured to control a nonvolatile memory, wherein
the memory controller has a speculative reading mode of reading in advance data predicted to be requested by the host from the nonvolatile memory,
the memory controller is configured to
record a physical address indicating a physical location of the nonvolatile memory at which data that is last requested to be read by the host is stored,
determine, when the host requests data to be read, whether or not to transition to the speculative reading mode, based on a physical address of the nonvolatile memory at which the requested data is stored and the recorded physical address, and
transition, when determining to transition to the speculative reading mode, to the speculative reading mode and reading, from the nonvolatile memory, data in a range determined with respect to a physical address associated with a logical address specified by the host.

17. A data reading method of a memory system comprising a nonvolatile memory and a memory controller connectable to a host and configured to control the nonvolatile memory, the memory controller having a speculative reading mode of reading in advance data predicted to be requested by the host from the nonvolatile memory,
the memory controller
recording a physical address indicating a physical location of the nonvolatile memory at which data that is last requested to be read by the host is stored,
when the host requests data to be read, determining whether to transition to the speculative reading mode, based on a physical address of the nonvolatile memory at which the requested data is stored and the recorded physical address, and
when determining to transition to the speculative reading mode, transitioning to the speculative reading mode and reading, from the nonvolatile memory, data in a range determined with respect to a physical address associated with a logical address specified by the host.
